(19) United States
(12) Patent Application Publication
(10) Pub. No.: US 2010/0127097 A1
(43) Pub. Date: May 27, 2010

(54) CONCEALED ELEVATED IRRIGATION SYSTEM

(76) Inventor: STEPHEN FRANK, St. Louis, MO (US)

Correspondence Address: CHARLES C. MCCLOSKEY, 763 S. NEW BALLAS ROAD STE. 305, ST. LOUIS, MO, 63141, US

(21) Appl. No.: 12/277,403

(22) Filed: Nov. 25, 2008

(51) Int. Cl. B05B 15/06

(52) U.S. Cl. 239/200

(57) ABSTRACT

A raised sprinkler head upon the top of a fence post delivers water in an aesthetically pleasing manner from a height above the ground for additional range. The sprinkler head blends with the decor of the fence post while the fence post provides a concealed water supply line that extends vertically. The water supply line of the fence post then connects to a buried irrigation supply line, or alternatively a hose. The present invention can be utilized inside of two fence posts and include a compatible fence section to make a pleasing arrangement to the eye.

### BACKGROUND OF THE INVENTION

The concealed elevated irrigation system generally relates to residential and commercial irrigation, and more specifically to irrigation lines and heads concealed within fencing suitable for residential and commercial settings.

With the dispersal of people from city centers to suburbs, people own more and more houses with lawns. In olden days, a lawn represented land taken out of agricultural production thus, a lawn indicated a well off landowner. In present times, lawns generally come with homes as an effect of zoning for single family detached homes. Detaching of homes by family spaces apart houses leaving room for lawns. Lawns generally have various grasses as the predominant plant.

Grasses generally have a shallow root structure with thin narrow leaves extending above the ground surface. The roots extend downwardly up to an inch. In rainy locations and other moist places, lawns and their grasses remain green and pleasing to people with a minimum of effort. In drier locations, often with infrequent rains and higher temperatures, lawns and their grasses turn brown in the absence of rain and the presence of heat.

To combat the browning of lawns, people water lawns as best they can. Homeowners have various water dispersing devices available. Sprinklers connected to hoses predominate as the water dispensing device of suburban home dwellers. Sprinklers come in many kinds, reciprocating, oscillating, spray nozzle, flat hose, and the like. Hoses also have many varieties, tubular, flat, drip, soaker, and the like. A sprinkler on a hose can be moved readily by a person to a selected location. However, the need to move hoses becomes their weakness. Moving hoses adds to the labor of watering a lawn.

### DESCRIPTION OF THE PRIOR ART

On a percentage basis, a few homeowners have installed irrigation systems. The systems generally bury irrigation water supply lines beneath a lawn and adjacent flower beds and have sprinkler heads that pop up to deliver water to a lawn. The irrigation systems have various control mechanisms, mechanical and electrical primarily, and some computerized. The controls allow a homeowner to set a watering schedule and forget about it. However, these irrigation systems have ground located sprinklers that encounter lawn mowers and rodents while having a limited sprinkling range.

Following the lead of irrigation for farmlands, some homeowners use elevated reciprocating sprinklers. These sprinklers use the same brass or plastic head with biased arm that interrupts water flow as it turns in a circular motion. These sprinklers though connect to the end of a raised pipe. The raised pipe is often galvanized steel upon a tripod base. However, these sprinklers leave their raised pipe exposed, unless concealed by shrubbery, which remains less than pleasing to the eye.

### SUMMARY OF THE INVENTION

Generally, the present invention incorporates a raised sprinkler head upon the top of a fence post. The sprinkler head blends with the decor of the fence post while the fence post provides a concealed water supply line that extends vertically. The water supply line of the fence post then connects to a buried irrigation supply line, or alternatively a hose. The present invention can be utilized inside of two fence posts and include a compatible fence section to make a pleasing arrangement to the eye.

There has thus been outlined, rather broadly, the more important features of the invention in order that the detailed description thereof that follows may be better understood and that the present contribution to the art may be better appreciated. The present invention also includes a variety of head styles, fittings for connection to a supply line, slots for connecting adjacent fence sections, and a cap upon the end of the fence post adjacent to the sprinkler head. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved concealed elevated irrigation system that avoids the disadvantages of the prior art.

Another object is to provide such a concealed elevated irrigation system that does not require a backflow preventer installed upon its connection to a supply line.

Another object is to provide such a concealed elevated irrigation system that avoids introduction of debris, mud, and sand into the head.

Another object is to provide such a concealed elevated irrigation system that avoids damage from ground level rodents, birds, insects, and animals.

Another object is to provide such a concealed elevated irrigation system that accepts various heads for altering the volume, range, and angle of a spray pattern.

Another object is to provide such a concealed elevated irrigation system that connects to an existing irrigation supply line with its own backflow preventer.

Another object is to provide such a concealed elevated irrigation system that operates in rocky locations or high water table areas where burying pipes has become prohibitive.

Another object is to provide such a concealed elevated irrigation system that a homeowner can install with light tools.

Another object is to provide such a concealed elevated irrigation system that avoids damage from errant gardeners emplacing tree spikes, planting bulbs, or turning over a garden, or lawn mowers, or underground roots.

Another object is to provide such a concealed elevated irrigation system that does not require a blow out of a line or the attention of a plumber.

Another object is to provide such a concealed elevated irrigation system that connects with a timer for automatic operation of the sprinkler.

Another object is to provide such a concealed elevated irrigation system that allows for simultaneous fence and sprinkler installation around swimming pools and other structures.

Another object is to provide such a concealed elevated irrigation system that allows for running of wires and installation of speakers.

Another object is to provide such a concealed elevated irrigation system that provides farther and better coverage of tall plants.

Another object is to provide such a concealed elevated irrigation system that operates as a stand alone pillar or column tastefully decorated to blend into a landscape.

Another object is to provide such a concealed elevated irrigation system that has a cap that avoids intrusion by moisture and insects within the post.

Another object is to provide such a concealed elevated irrigation system that avoids knocking off petals from flowers.

Another object is to provide such a concealed elevated irrigation system that delivers water from above plants and flowers to mimic rainfall.

Another object is to provide such a concealed elevated irrigation system that may operate automatically upon an inexpensive clock mechanism.

Another object is to provide such a concealed elevated irrigation system that avoids placement of wiring in ground that is susceptible to lightning and other damage to electrical systems.

And, another object is to provide such a concealed elevated irrigation system that is capable of manufacturing at a low cost for eventual purchase by consumers at an acceptable retail price.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates a front view of the components of the present invention as installed on location;

FIG. 2 shows the interior face of a post of the present invention;

FIG. 3 shows the end face, opposite FIG. 2, of a post of the present invention;

FIG. 4 provides a detailed view of the top of a post of the present invention;

FIG. 5 describes a bottom view of a post; and,

FIG. 6 describes another bottom view of a post of the present invention.

The same reference numerals refer to the same parts throughout the various figures.

### DESCRIPTION OF THE PREFERRED EMBODIMENT

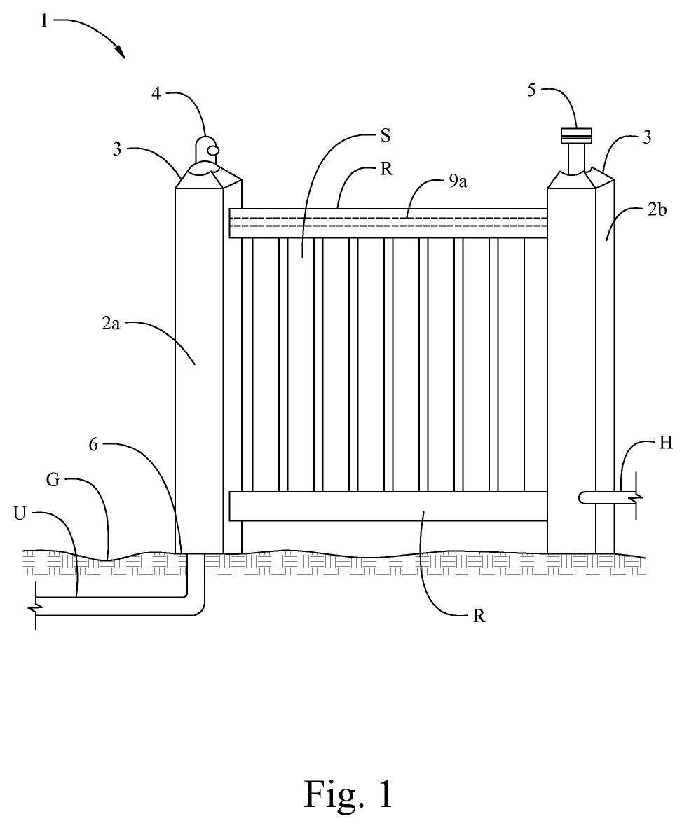

The present invention overcomes the prior art limitations and provides a concealed elevated irrigation system. Turning to FIG. 1, the system of the present invention generally installs upon a lawn or proximate a garden, either flower or vegetable. The system has a plurality of upright slats S contained within two mutually parallel and spaced apart rails R. The rails then secure upon posts 2 of the present invention. Though slats and rails are shown, the posts may stand alone in a landscape, as columns or pillars, as shown in later figures. In FIG. 1, the left post 2a receives irrigation water from an underground line U. The line U connects directly to the bottom of the post. Opposite the left post, FIG. 1 shows a right post 2b that has its irrigation water delivered by a hose H or other temporary water supply. Both the underground line U and the hose H supply irrigation water into the posts 2 for delivery by the present invention to the nearby landscape. Additionally, the present invention includes a low pressure drain valve, or sometimes called a king's valve, in the underground line U or the hose H before the post. The low pressure drain valve releases water from the system when the water supply is ceased as during maintenance or cold weather shutdown of the system. The low pressure drain valve can also be located proximate a backflow prevention device as further protection for the water supply system. In an alternate embodiment, the upper of the rails R includes a lateral line 9a that conveys water between two posts 2.

The posts 2 are generally embedded within a horizontal surface, or ground G, beneath the lower of the rails R. Each post has a top 3 generally locating opposite the ground. The top has a centered opening that receives a water dispensing fitting, here a rotor 4 on the left post 2a and a sprayhead 5 on the right post 2b. Each fitting receives the water supplied to the invention and dispenses the water outwardly from the post as directed by the user. Each post is generally elongated and slender to blend into the landscape architecture. To avoid nearby shrubbery and maximize the range of water dispensed by the fittings, each post locates a water dispensing fitting at least three feet above the nearby ground surface.

The range of the water dispensed from a head remains governed by projectile motion. As the head is elevated, the range increases as the water dispensed falls back to the ground at an elevation below the sprinkler. The range, R, of the water is determined by a solution for time, t, in the following equations:

$$0 = {y}_{o} + {v}_{o} sin Θ t - \frac{{gt}^{2}}{2} and , \\ R = {v}_{o} cos Θ t$$

which generally yields an improved range of:

$${y}_{o} + \frac{{v}_{o}^{2} sin 2 Θ}{g}$$

where the maximum range governed by the pressure and angle of the water dispensing head is augmented by the elevation of the water dispensing head as the water descends below the water dispensing head elevation at an approximately 45° angle.

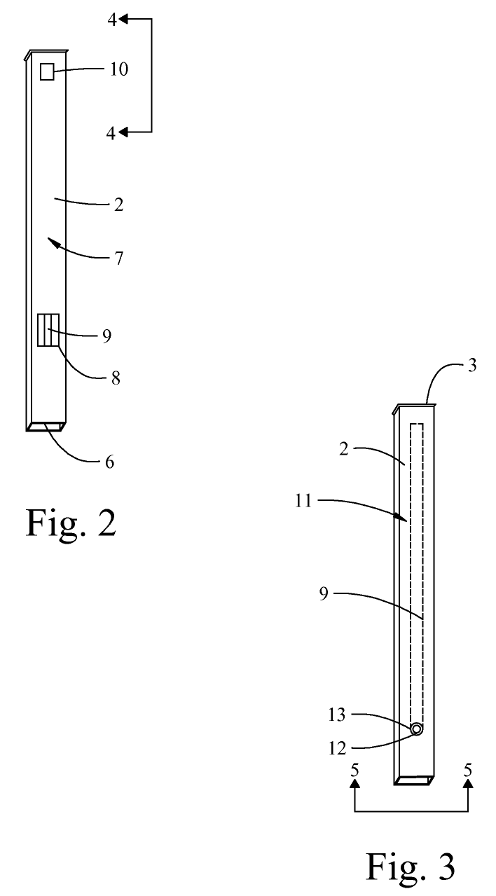

FIG. 2 shows a post of the present invention, generally like post 2a. Here, the post has a generally rectangular cross section with four sides though round and other cross sections are foreseen. The post is generally hollow and has a base 6 for insertion into the ground opposite the top 3. One of the sides of the post is an interior face 7 that extends for the length of the post. Near the base, the interior face has a first slot 8 that extends through the thickness of the interior face. The slot has a shape to receive a rail R as previously shown in FIG. 1. The slot 8 also shows the riser 9 that extends within the post from near the base upwardly to the top and its fitting 4, 5. The riser is generally an elongated tube secured within the post. In the preferred embodiment, the riser is formed integrally with the post on present day extrusion machinery. The riser and interior face continue upwardly from the base towards the top 3. Below the top, the interior face has a second slot 10. The second slot also receives a rail R as previously shown. The second slot also shows the termination of the riser into the fitting 4, 5. In an embodiment of the invention with a single panel of slats and rails, the interior face has the first slot and the second slot locating thereon.

Turning the post of FIG. 2, FIG. 3 shows a post of the present invention, generally like post 2b. The post also has a generally rectangular cross section with four sides though other cross sections are anticipated such as round. The hollow post has a base 6 for insertion into the ground opposite the top 3. Opposite the interior face 7, another side of the post is the end face 11 that extends for the length of the post. Near the base, the end face has an aperture 12 with a lower connection 13 for connecting to a hose H. The aperture is generally smaller in dimension that the first slot on the interior face. The end face then continues upwardly towards the top without interruption. The end face generally has a smooth appearance visible outside of the installed embodiment. Within this post and extending upwardly from the lower connection 13, this post also has the riser 9. The riser continues upwardly to the top and its fitting, here shown in phantom. The riser is generally an elongated tube secured within the post. In the preferred embodiment, the riser is formed integrally with the post on present day extrusion machinery. The riser and end face continue upwardly from the base towards the top 3. In an embodiment of the invention with a single panel of slats and rails, the end face is shown outwardly of the panel of slats, presenting a clean appearance. In an alternate embodiment with multiple panels of slats, the end face has a pattern of knockouts for providing slots in similar locations as upon the interior face. Thus the post can be used in a sequence of panels such as along a line of fencing.

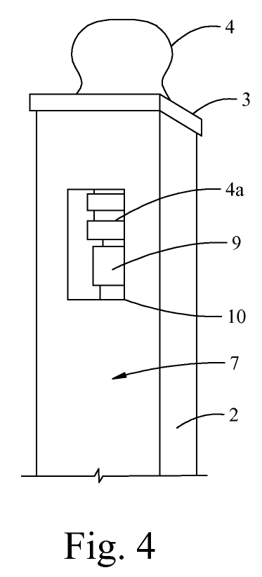

In more detail, FIG. 4 shows the head 4 near the top 3 of a post 2. The head rests upon the finished top and then extends into the post to approximately the slot 10 for the upper rail R. The slot is in the interior face 7 of the post and shows the head 4 connecting to the riser 9. The head connects to the riser axially using a fitting 4a, such as a union. The embodiment shown allows for a connection to one head only. In an alternate embodiment, the fitting is a tee that allows for a head connection and a connection to a lateral that extends through a rail to the next post. The alternate embodiment allows for usage of two heads upon a panel. In a further alternate embodiment, the fitting is a double tee that has a connection for a head and also connections for two coaxial laterals. The further alternate embodiment allows for the posts and panels to assemble into a fence where multiple posts have heads for dispensing water. In the alternate embodiments, the various heads along a line of laterals may have reduced range of dispensing water.

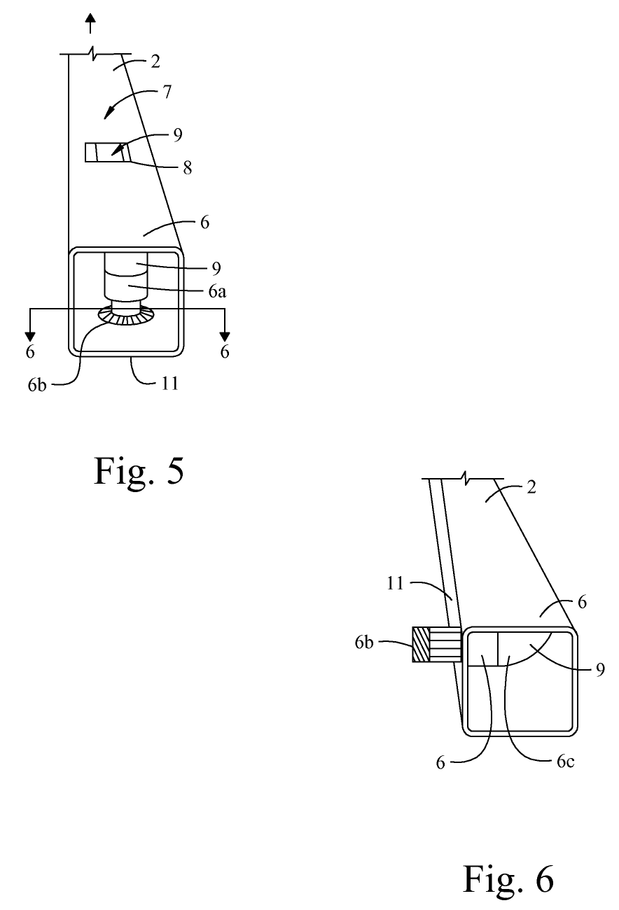

Opposite FIG. 4, FIG. 5 shows the base 6 of a post 2 and its connection for a supply line U or hose H. The post has the interior face 7 and a slot 8 locating towards the base that generally receives the lower rail R. The slot shows the riser 9 extending parallel to the length of the post towards the base. At the base, the post has its generally hollow rectangular cross section. The riser connects to its fitting 6a and the fitting extends to a lower connection 6b that passes through an aperture in the end face 11.

Turning the base, FIG. 6 provides a view of the base 6 of a post 2. The riser 9 descends through the post and at the base connects with a fitting 6a here through an elbow 6c. The fitting then positions the lower connection 6b through the end face 11 and away from the post for connection to a hose or supply line of an irrigation system. Though posts with risers have been described, the inventor anticipates that the posts and risers can be extruded simultaneously as a single unit during manufacture, particularly using plastic resins. The posts would then have integral risers for ready installation and connection. The posts may be extruded with multiple risers therein and preferably four risers within a rectangular cross section post. A round post may preferably have three risers extruded therein for stability of the post though up to four risers are also foreseen by the Applicant. The present invention locates the risers within the posts primarily and alternately as laterals within the rails so that water reaches the rotors, heads, and water dispensing fittings without being seen.

From the aforementioned description, a concealed elevated irrigation system has been described. This irrigation system is uniquely capable of sprinkling, or delivering water from a height above the ground while concealing the risers of water within pleasing structural elements, primarily a post. This irrigation system and its various components may be manufactured from many materials, including but not limited to, polymers, polyvinyl chloride, high density polyethylene, polypropylene, nylon, steel, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A system for delivering water at an elevation to a landscape while concealed, comprising:
at least one post, generally elongated and hollow, having a base and an opposite top;
at least one riser locating within said post extending from proximate said base through said top, said riser having a dispensing fitting thereon and locating above said top; and,
a connection locating proximate said base adapted to connect to a source of water.

2. The concealed elevated water delivery system of claim 1 further comprising:
said post having an interior face extending from said base to said top and an opposite end face extending from said base to said top; and,
said interior face having a first slot proximate said base and a second slot proximate said top.

3. The concealed elevated water delivery system of claim 2 further comprising:
said riser being generally tubular and elongated, and securing to said post; and,
said riser having a fitting thereon proximate said base wherein said riser connects directly to a source of water.

4. The concealed elevated water delivery system of claim 3 wherein said dispensing fitting is one of a rotor or a spray head and wherein said post is at least three feet tall.

5. The concealed elevated water delivery system of claim 2 further comprising:
at least one rail, connecting into one of said first slot or said second slot.

6. The concealed elevated water delivery system of claim 5 further comprising:
said at least one rail having at least one lateral therein for conveying water to an additional post, said at least one lateral being generally tubular and elongated, and securing to said rail.

7. The concealed elevated water delivery system of claim 1 further comprising:
said post having an interior face extending from said base to said top and an opposite end face extending from said base to said top; and,
said end face having an aperture proximate said base.

8. The concealed elevated water delivery system of claim 7 further comprising:
said riser being generally tubular and elongated and securing to said post; and,
said riser having a lower connection thereon proximate said base wherein said lower connection passes into said aperture for connection to a source of water slightly above said base.

9. The concealed elevated water delivery system of claim 8 wherein said dispensing fitting is one of a rotor or a spray head and wherein said post is at least three feet tall.

10. The concealed elevated water delivery system of claim 2 further comprising:
at least one rail, connecting into one of said first slot or said second slot and said at least one rail having a lateral therein for conveying water to an additional post, said at least one lateral being generally tubular and elongated, and securing to said at least one rail.

11. The concealed elevated water delivery system of claim 2 further comprising:
two of said risers locating within said post, said risers avoiding said first slot and said second slot and said risers being equally spaced apart.

12. The concealed elevated water delivery system of claim 2 further comprising:
four of said risers locating within said post, said risers avoiding said first slot and said second slot and said risers being equally spaced apart.

13. The concealed elevated water delivery system of claim 1 further comprising:
said connection including a low pressure drain valve outwardly of said post, said low pressure drain valve opening when the delivery of water to said system ceases.

14. The concealed elevated water delivery system of claim 2 further comprising:
said at least one riser being integral with said at least one post.
